(19) United States
(12) Patent Application Publication
(10) Pub. No.: US 2019/0325854 A1
(43) Pub. Date: Oct. 24, 2019

(54) MUSIC GENRE CHANGING SYSTEM

(71) Applicant: Riley Kovacs, Ancaster (CA)

(72) Inventor: Riley Kovacs, Ancaster (CA)

(21) Appl. No.: 15/956,464

(22) Filed: Apr. 18, 2018

(51) Int. Cl. G10H 1/00; G11B 27/031

(52) U.S. Cl. CPC G10H 1/0025; G11B 27/031; G10H 2210/036; G10H 2210/071; G10H 2210/076; G10H 2210/061; G10H 2240/016

(57) ABSTRACT

A music genre changing system and method including a platform for artists to license and generate a song with three versions of the song. The music genre changing system provides means to reach additional listeners with different tastes in music and allows artists to explore new genres of music. Each of the plurality of versions of the music audio file (song) consists of a custom content file of the same or a different genre. Lyrics, instrumentals, tone, and beat used may be converted and modified to create two variations of the original music audio file to provide three versions of one song.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of music and more specifically relates to digital audio data licensing platforms.

### 2. DESCRIPTION OF RELATED ART

Music is an art form and cultural activity whose medium is sound organized in time. Music is performed with a vast range of instruments and vocal techniques ranging from singing to rapping; there are solely instrumental pieces, solely vocal pieces and pieces that combine singing and instruments. Music can be divided into genres (e.g., country music) and genres can be further divided into subgenres. The music industry includes the individuals who create new songs and musical pieces. An artist may not want to commit to a single genre of music. It may be difficult to reach listeners with a single style or genre. A suitable solution is desired.

U.S. Pat. No. 7,078,607 to Anton Perry Alferness relates to dynamically changing music. The described dynamically changing music includes dynamically changing musical compositions and sound compositions. Provided is a dynamic music sound file format, as well as an illustrative operating environment in which the invention may be practiced. The sound file includes many different characteristics relating to the components that are easily accessible. Each time the user listens to a song or sound composition, it may change. For example, the user may listen to a song and then play the same song again and hear a different version of the song. A script tool is used to create scripts that are used to play back a song. The scripts are user definable and may, for example, define a specific order to play the components, define the components that may be played next to each other during the playback. The possibilities for new music experience are expanded, adding tremendous value for the listener and tremendous creative opportunities for the artists.

### BRIEF SUMMARY OF THE INVENTION

In view of the foregoing disadvantages inherent in the known music art, the present disclosure provides a novel music genre changing system. The general purpose of the present disclosure, which will be described subsequently in greater detail, is to provide a method for dynamically changing musical compositions and sound compositions to provide multiple genres of a single song. This enables music artists to be creative in different genres of music to reach a greater number of potential listeners and purchasers.

A music genre changing system is disclosed herein. The music genre changing system includes a platform for artists to license and generate a song with three versions of the song. The music genre changing system provides means to reach additional listeners with different tastes in music and allows artists to explore new genres of music. Each of the plurality of versions of the music audio file (song) consists of a custom content file of a different version which may be in the same genre or a different genre per artist selection. Each of the three versions of the music audio file includes the custom content file with varying versions of audio output. The versions of the music audio file include an original song and two variations. Each of the two variations is selected from a similar genre to the original song. Lyrics, instrumentals, tone, and beat used may be converted and modified to create the two variations of the music audio file. The music audio file includes a title, selected by an artist, to represent the each of the three versions of the music audio file.

A method of using music genre changing system is also disclosed herein. The method of using music genre changing system may comprise the steps of: providing a music genre changing system for generating multiple genres from an individual song; providing a previously recorded music audio file having a sound composition configured to be converted into three versions of the sound composition of the music audio file; converting and modifying the music audio file to a selected three different versions of the music audio file; and generating a Trillium including content for the three versions of the music audio file. The method may include licensing the previously recorded music audio file through the music genre changing system (“Trillium”). The music audio files may be downloaded and played on a playback device.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a music genre changing system, constructed and operative according to the teachings of the present disclosure.

FIG. 1 is a flow diagram illustrating a method of use for music genre changing system, according to an embodiment of the present disclosure.

FIG. 2 is a flow diagram illustrating a method of use for music genre changing system, according to an embodiment of the present disclosure.

FIG. 3 is a flow diagram illustrating a method of use for music genre changing system, according to an embodiment of the present disclosure.

FIG. 4 is a screen view of the music genre changing system during an ‘in-use’ condition, according to an embodiment of the disclosure.

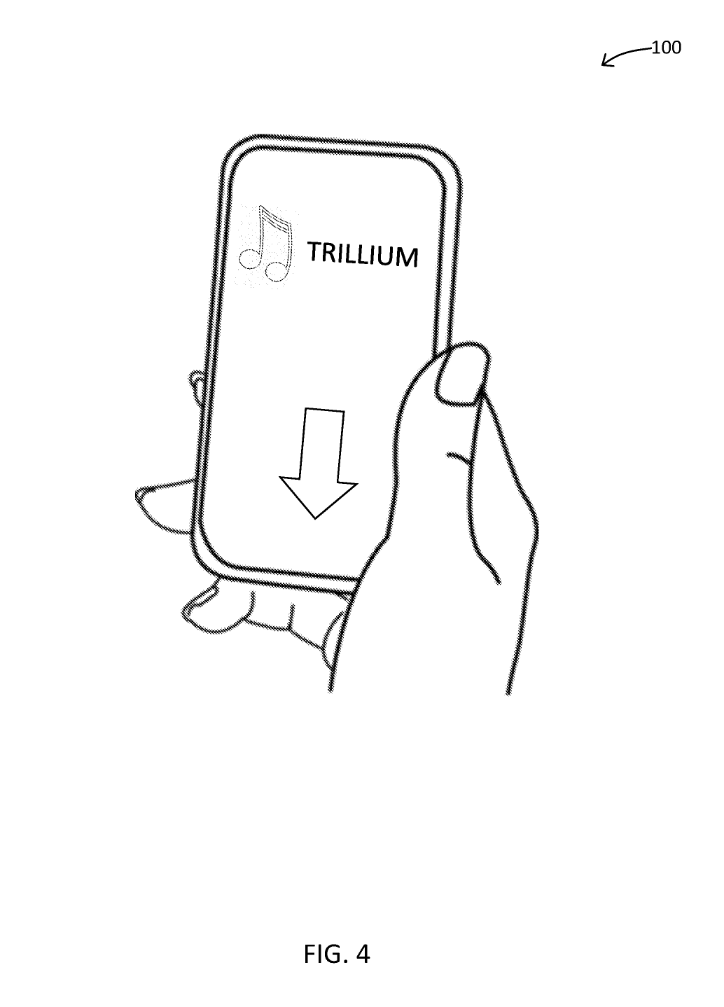

The various embodiments of the present invention will hereinafter be described in conjunction with the appended drawings, wherein like designations denote like elements.

### DETAILED DESCRIPTION

As discussed above, embodiments of the present disclosure relate to music and more particularly to a music genre changing system as used to improve music and enable artists to be creative in different genres for different listeners.

Generally, the invention gives music artists/creators the opportunity to create 3 different versions of the same song, i.e., 1^{st}, ‘Original Theme’ (pop) 2^{nd}, ‘Country’ and a 3^{rd}, ‘Rock’ version. A music artist may decide if and what song they would like to make a Trillium out of. A chosen song by the artist may be licensed through the program to create multiple versions of that song. This enables artists to try new ways of creating music but also gives the artist an opportunity to create and try new genres of music thus expanding their reach in the music market. Once multiple versions of the song are created the song can then be identified as a ‘Trillium’ song. The song can then be sold in multiple versions across multiple streaming and downloading services and played on a playback device. The present invention allows artists to try new genres and to expand in the music market.

Music genre changing system, “Trillium” is a service that provides music artists and other creators the opportunity to expand the reach of their fans and listeners, but also to work with other artists without having the compromise of being limited to only one single song. Trillium offers artists the ability to create one song in 3 different versions with subtle changes in lyrics, tune, rhythm or beat, changes in genre of music, or featuring different artists. Different instrumentals, rhythms, and beats may be used as suited for the genre selected for a version of the song. An artist may sing and create songs in different languages as well.

The music genre changing system provides a means to gain access to more listeners as well as new listeners (as a method of monetizing). Artists may choose a suitable title to represent each version in their selection of three versions of the song. Artists can decide how many songs they want from an album or singles to incorporate Trillium.

Artists may feature in each others' Trilliums. Ambient versions of a song may feature little to no lyrics. In a preferred embodiment, the three versions of the song may be selected from a similar genre of music. As an example, the three versions may include a pop original and two other versions within the same pop genre. As another example, the three versions may include an ambient original, EDM version, and a lyrical version. Finally, a folk original may be provided with an acoustic version and a reggae version. The Trillium genre selections may be selected from a plethora of genres suitable to an artist. Trillium is designed to increase attraction for artists and increase revenue, downloads, and licensing. Trillium may have music awards for artists using the service.

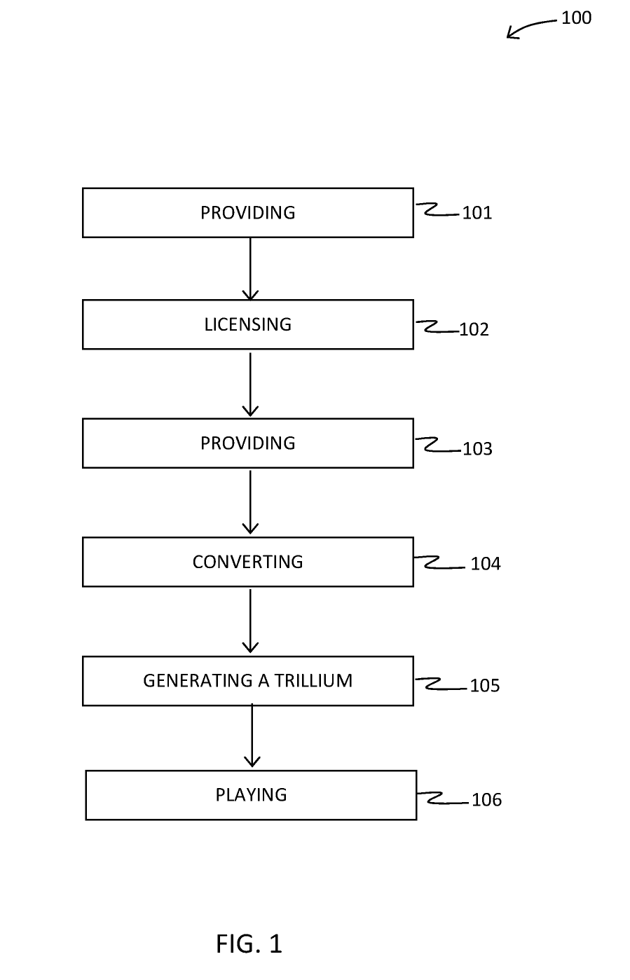

Referring now more specifically to the drawings by numerals of reference, there is shown in FIG. 1 a flow diagram illustrating a method for generating multiple genres from a single song, according to an embodiment of the present disclosure. As illustrated, the method for generating multiple genres from a single song may include the steps of: step one 101, providing a music genre changing system 100 for generating multiple genres from an individual song; step two 102, providing a previously recorded music audio file having a sound composition configured to be converted into at least three versions of the sound composition of the music audio file; step three 103, converting and modifying the music audio file to a selected one of the at least three versions of the music audio file; step four 104, and generating a trillium including content for the at least three versions of the music audio file. The trillium is comprised of the three versions of the music audio file including the original song and two of the variations. The music genre changing system 100 provides a collaborative music platform that allows artists to transform their songs into multiple genres.

The method includes licensing 105 the previously recorded music audio file through the music genre changing system 100. Then an artist may create the trillium including content for the at least three versions of the music audio file. A listener may download and play 105 the music audio file on a playback device.

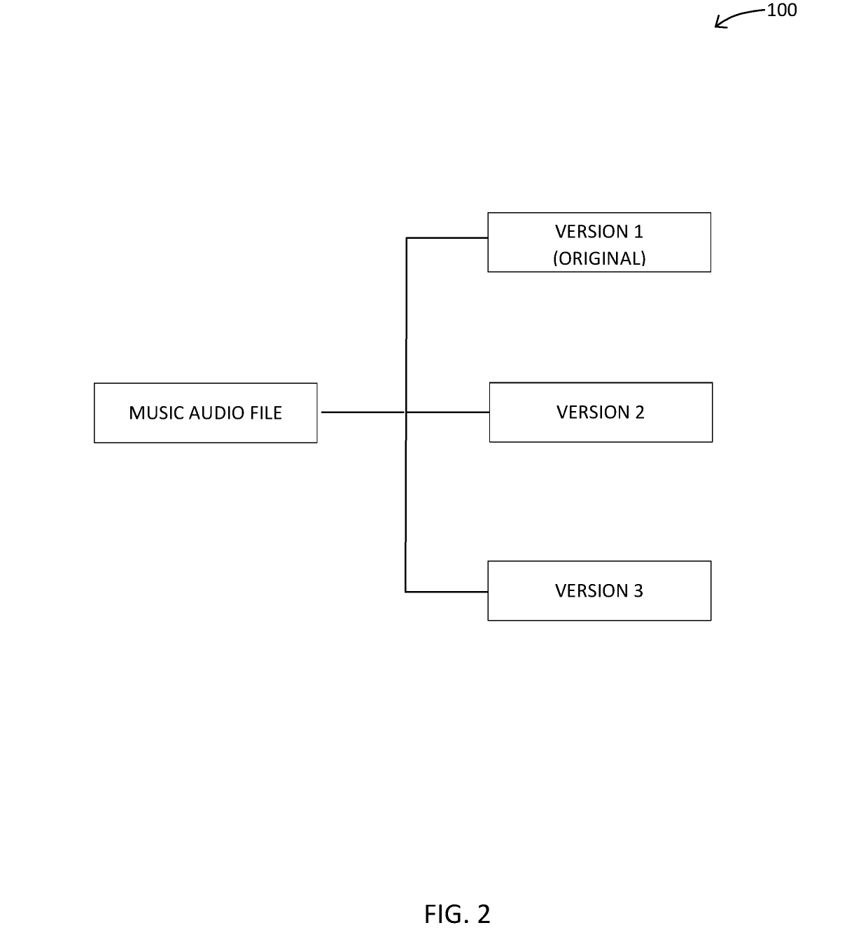

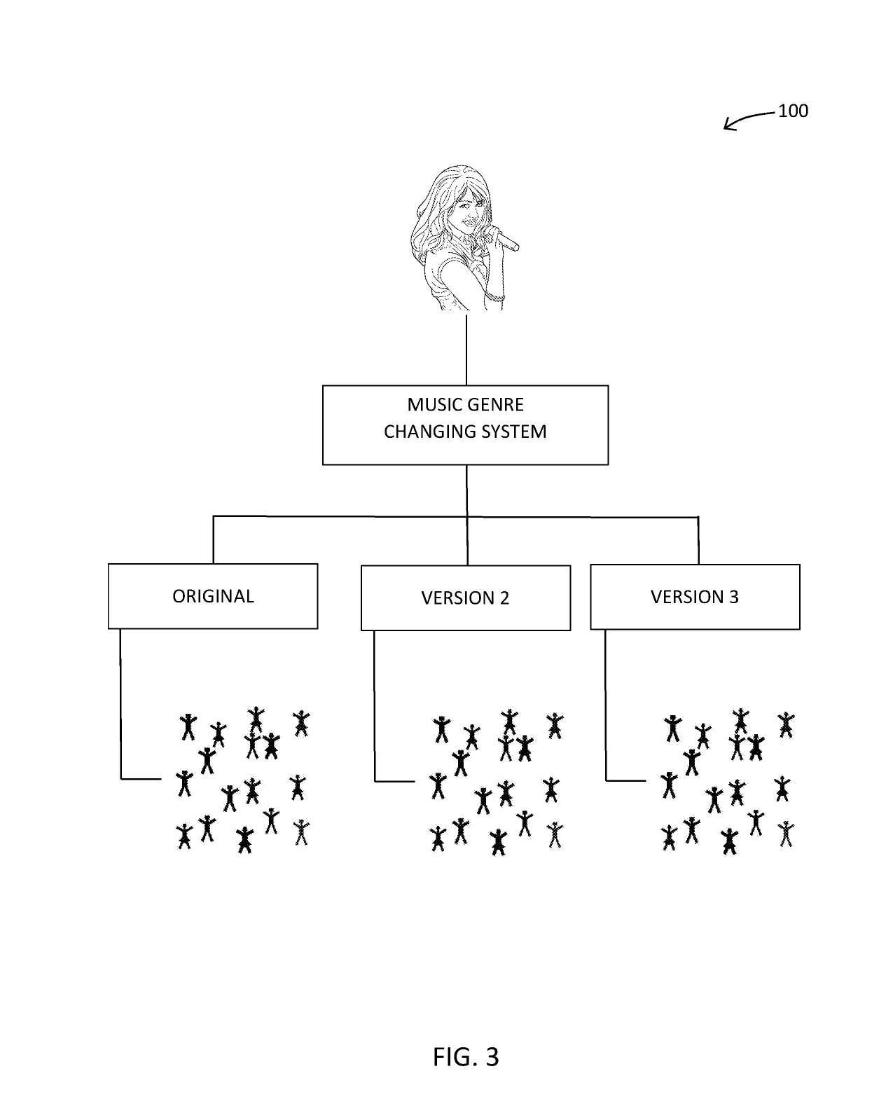

As shown in FIGS. 2-3, the music genre changing system 100 is a platform for generating the at least three versions of the song. Each of the plurality of versions of the music audio file (song) each consists of a custom content file of a different genre. Each of the three versions of the music audio file includes the custom content file with varying versions of audio output. The versions of the music audio file include an original song (version 1) and two variations (version 2 and 3). Each of the two variations are selected from a similar the genre to the original song. Lyrics, instrumentals, tone, and beat used may be converted and modified to create the two variations of the music audio file. The music audio file includes a title to represent the each of the three versions of the music audio file. The at least three versions of the sound composition are configured to reach additional listeners having different musical interests and likes.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for generating multiple genres from a single song 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A method for generating multiple genres from a single song comprising:
providing a music genre changing system for generating multiple genres from an individual song;
providing a previously recorded music audio file having a sound composition configured to be converted into at least three versions of said sound composition of said music audio file;
converting and modifying said music audio file to a selected one of said at least three versions of said music audio file; and
generating a trillium including content for said at least three versions of said music audio file.

2. The method of claim 1, wherein each of said plurality of versions of said music audio file each consists of a custom content file of a different genre.

3. The method of claim 1, wherein each of said three versions of said music audio file include said custom content file with varying versions of audio output.

4. The method of claim 1, further includes playing said music audio file through a playback device.

5. The method of claim 1, wherein said converting and modifying said music audio file includes changes in lyrics.

6. The method of claim 1, wherein said converting and modifying said music audio file includes changes in instrumentals, tone, and beat used.

7. The method of claim 1, wherein said at least three versions of said music audio file includes an original song and two variations.

8. The method of claim 7, wherein each of said two variations are selected from a similar said genre to said original song.

9. The method of claim 1, further includes licensing said previously recorded music audio file through said music genre changing system.

10. The method of claim 1, wherein said music audio file includes a title to represent said each of said three versions of said music audio file.

11. The method of claim 1, wherein said at least three versions of said sound composition are configured to reach additional listeners having different musical interests and likes.

12. The method of claim 1, wherein said music genre changing system is a platform for generating said at least three versions of said song.

13. The method of claim 1, wherein said music audio file is said song.

14. The method of claim 1, wherein said trillium is comprised of said three versions of said music audio file including said original song and two of said variations.

15. A method for generating multiple genres from a single song comprising:
providing a music genre changing system for generating multiple genres from an individual song;
licensing a previously recorded music audio file through said music genre changing system;
providing said previously recorded music audio file having a sound composition configured to be converted into three versions of said sound composition of said music audio file;
converting and modifying said music audio file to a selected one of said three versions of said music audio file;
generating a trillium including content for said three versions of said music audio file; and
playing said music audio file through a playback device.

16. The method for generating multiple genres from a single song of claim 15 wherein said trillium is comprised of said three versions of said music audio file including said original song and two of said variations.

17. The method for generating multiple genres from a single song of claim 15, wherein said three versions of said music audio file includes an original song and two variations.

18. The method for generating multiple genres from a single song of claim 15, wherein said converting and modifying said music audio file includes changes in lyrics, instrumentals, tone, and beat used.

19. The method for generating multiple genres from a single song of claim 15, wherein said music genre changing system is a platform for licensing and generating said three versions of said song.

20. A method for generating multiple genres from a single song comprising:
providing a music genre changing system for generating multiple genres from an individual song;
licensing a previously recorded music audio file through said music genre changing system;
providing said previously recorded music audio file having a sound composition configured to be converted into three versions of said sound composition of said music audio file;
converting and modifying said music audio file to a selected one of said three versions of said music audio file;
generating a trillium including content for said three versions of said music audio file; and
playing said music audio file through a playback device;
wherein each of said plurality of versions of said music audio file consists of a custom content file of a different genre;
wherein each of said three versions of said music audio file include said custom content file with varying versions of audio output;
wherein said converting and modifying said music audio file includes changes in lyrics;
wherein said converting and modifying said music audio file includes changes in instrumentals, tone, and beat used;
wherein said three versions of said music audio file includes an original song and two variations;
wherein each of said two variations are selected from a similar genre to said original song;
wherein said music audio file includes a title to represent said each of said three versions of said music audio file;
wherein said music audio file includes said song;
wherein said music genre changing system is a platform for licensing and generating said three versions of said song;
wherein said three versions of said sound composition are configured to reach additional listeners having different musical interests and likes; and
wherein said trillium is comprised of said three versions of said music audio file including said original song and two of said variations.
